(19) United States
(12) Patent Application Publication
(10) Pub. No.: US 2016/0341165 A1
(43) Pub. Date: Nov. 24, 2016

(54) INJECTOR

(71) Applicant: HONDA MOTOR CO., LTD., Tokyo (JP)

(72) Inventors: Naohiro ISHIKAWA, Wako (JP); Kazuji ONO, Wako (JP)

(73) Assignee: HONDA MOTOR CO., LTD., Tokyo (JP)

(21) Appl. No.: 15/084,491

(22) Filed: Mar. 30, 2016

(30) Foreign Application Priority Data
May 20, 2015 (JP) 2015-102801

(51) Int. Cl. F02M 61/18; F02M 61/04

(52) U.S. Cl. CPC F02M 61/1806; F02M 61/04

(57) ABSTRACT

An injector includes a nozzle distal end portion. The nozzle distal end portion has an inner surface and an outer surface. The inner surface has a valve seat which has an annular shape on the inner surface. The nozzle distal end portion has a plurality of injection holes penetrating through the nozzle distal end portion. Each of the plurality of injection holes is defined by a hole wall which has a hole-wall inner portion and a hole-wall outer portion. An angle between the inner surface and the hole-wall inner portion is an acute angle. An angle between the inner surface and the hole-wall outer portion is an obtuse angle. A first recess portion is provided on the inner surface to extend to the hole-wall outer portion.

### CROSS-REFERENCE TO RELATED APPLICATIONS

The present application claims priority under 35 U.S.C. §119 to Japanese Patent Application No. 2015-102801, filed May 20, 2015, entitled “Injector.” The contents of this application are incorporated herein by reference in their entirety.

### BACKGROUND

1. Field

The present invention relates to an injector.

2. Description of the Related Art

Examples of a direct injector for an internal combustion engine for an automobile include the following known direct injector. This direct injector includes a nozzle, a plurality of injection holes, a valve body, a spring, and a solenoid. The nozzle has a channel for fuel therein. The injection holes are formed in a nozzle distal end portion. The valve body is displaceably contained in the nozzle. The spring urges the valve body toward the nozzle distal end portion side. The solenoid displaces the valve body in a direction separating from the nozzle distal end portion against the urging force of the spring. An inner surface of the nozzle distal end portion has a recessed tapered surface centered at the nozzle axis and has an annular valve seat centered at the nozzle axis. The injection holes are formed closer to a central portion than the valve seat in the nozzle distal end portion. In order to close a valve, a distal end portion of the valve body urged by the spring is brought into contact with the valve seat so as to interrupt supply of the fuel into the injection holes. In order to open the valve, the valve body is attracted to the solenoid due to power supplied to the solenoid, and accordingly, the valve body is separated from the nozzle distal end portion against the urging force of the spring. Thus, a distal end portion of the valve body is separated from the valve seat, and the fuel flows from an outer circumferential side to a central side of the inner surface of the nozzle distal end portion and is supplied into the injection holes.

In some of such injectors, the positions and orientations of the plurality of injection holes relative to the nozzle axis are set to be different from one another so as to form a rich air-fuel mixture around an ignition plug and a lean air-fuel mixture around the rich air-fuel mixture (for example, Japanese Unexamined Patent Application Publication No. 2007-278233).

### SUMMARY

According to one aspect of the present invention, an injector includes a nozzle and a valve body. The nozzle includes a cylindrical nozzle main body and a nozzle distal end portion. The cylindrical nozzle main body extends along a specified nozzle axis and has therein a channel for fuel through which the fuel flows. The nozzle distal end portion closes a distal end of the nozzle main body. The nozzle distal end portion has a valve seat in an inner surface facing a channel side and a plurality of injection holes penetrating through the nozzle distal end portion from the inner surface of the nozzle distal end portion to an outer surface of the nozzle distal end portion. The valve body is contained in the channel such that the valve body is displaceable along the nozzle axis and that is able to sit on the valve seat. The inner surface of the nozzle distal end portion has a tapered surface in which a central side is inclined toward a distal end side around the nozzle axis as a center. The valve seat is formed in the inner surface to have an annular shape centered at the nozzle axis. Each of the plurality of injection holes has an inner-surface-side open end disposed closer to the central side than an outer circumferential edge of the valve seat. Each of the plurality of injection holes has a hole-wall inner portion that forms part of a hole wall of the injection hole on a nozzle axis side and a hole-wall outer portion that forms part of the hole wall of the injection hole on an opposite side to the nozzle axis. The plurality of injection holes include at least one first injection hole. An angle formed between the hole-wall inner portion of the at least one first injection hole and the inner surface is an acute angle. An angle formed between the hole-wall outer portion of the at least one first injection hole and the inner surface is an obtuse angle. A first recess portion is provided so as to extend from the inner surface to the hole-wall outer portion of the at least one first injection hole.

According to another aspect of the present invention, an injector includes a cylindrical nozzle main body, a nozzle distal end portion, and a valve body. The cylindrical nozzle main body has a nozzle axis and a channel which extends along the nozzle axis to a distal end of the cylindrical nozzle main body and through which the fuel flows. The nozzle distal end portion is connected to the distal end of the cylindrical nozzle main body and has an inner surface and an outer surface opposite to the inner surface in the nozzle axis. The inner surface faces the channel and has a valve seat which has an annular shape on the inner surface having a center at the nozzle axis. The nozzle distal end portion has a plurality of injection holes penetrating through the nozzle distal end portion from the inner surface of the outer surface. The plurality of injection holes has on the inner surface an inner-surface-side opening which is provided between the nozzle axis and an outer circumferential edge of the valve seat. Each of the plurality of injection holes is defined by a hole wall which has a hole-wall inner portion closest to the nozzle axis and a hole-wall outer portion furthest from the nozzle axis. The plurality of injection holes includes at least one first injection hole. An angle between the inner surface and the hole-wall inner portion of the at least one first injection hole is an acute angle. An angle between the inner surface and the hole-wall outer portion of the at least one first injection hole is an obtuse angle. A first recess portion is provided on the inner surface to extend to the hole-wall outer portion of the at least one first injection hole. the valve body is provided in the channel and is movable along the nozzle axis to be able to sit on the valve seat.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a sectional view of an internal combustion engine that includes an injector according to a first embodiment.

FIG. 2 is a sectional view of the injector.

FIG. 3 is a sectional view of a nozzle distal end portion taken along line III-III of FIG. 5 and line III-III of FIG. 6.

FIG. 4 is a sectional view of the nozzle distal end portion taken along line IV-IV of FIG. 5 and line IV-IV of FIG. 6.

FIG. 5 is a plan view of the nozzle distal end portion seen from an inner surface side.

FIG. 6 is a plan view of the nozzle distal end portion seen from an outer surface side.

FIG. 7A is a graph illustrating the relationship between the depth of a recess portion and the distribution ratio of the second and third injection holes, and FIG. 7B is a graph illustrating the relationship between the depth of a recess portion and the distribution ratio of the fourth and fifth injection holes.

FIG. 8A illustrates a flow of fuel according to a comparative example in the case where an angle formed between a hole-wall outer portion and a tapered surface is an obtuse angle and an angle formed between a hole-wall inner portion and the tapered surface is an acute angle, and FIG. 8B illustrates a flow of the fuel according to the comparative example in the case where the angle formed between the hole-wall outer portion and the tapered surface is an acute angle and the angle formed between the hole-wall inner portion and the tapered surface is an obtuse angle.

FIG. 9A illustrates a flow of the fuel according to the first embodiment in the case where an angle formed between a hole-wall outer portion and a tapered surface is an obtuse angle and an angle formed between a hole-wall inner portion and the tapered surface is an acute angle, and FIG. 9B illustrates a flow of the fuel according to the first embodiment in the case where the angle formed between the hole-wall outer portion and the tapered surface is an acute angle and the angle formed between the hole-wall inner portion and the tapered surface is an obtuse angle.

FIG. 10A is a photograph of a spray shape of the fuel with the injector according to the first embodiment, and FIG. 10B is a photograph of a spray shape of the fuel with an injector according to the comparative example.

FIG. 11 is a plan view of the nozzle distal end portion according to a second embodiment seen from the inner surface side.

### DESCRIPTION OF THE EMBODIMENTS

The embodiments will now be described with reference to the accompanying drawings, wherein like reference numerals designate corresponding or identical elements throughout the various drawings.

An embodiment of the present disclosure applied to a fuel injector for a direct-injection internal combustion engine for an automobile will be described in detail below with reference to the drawings.

### First Embodiment

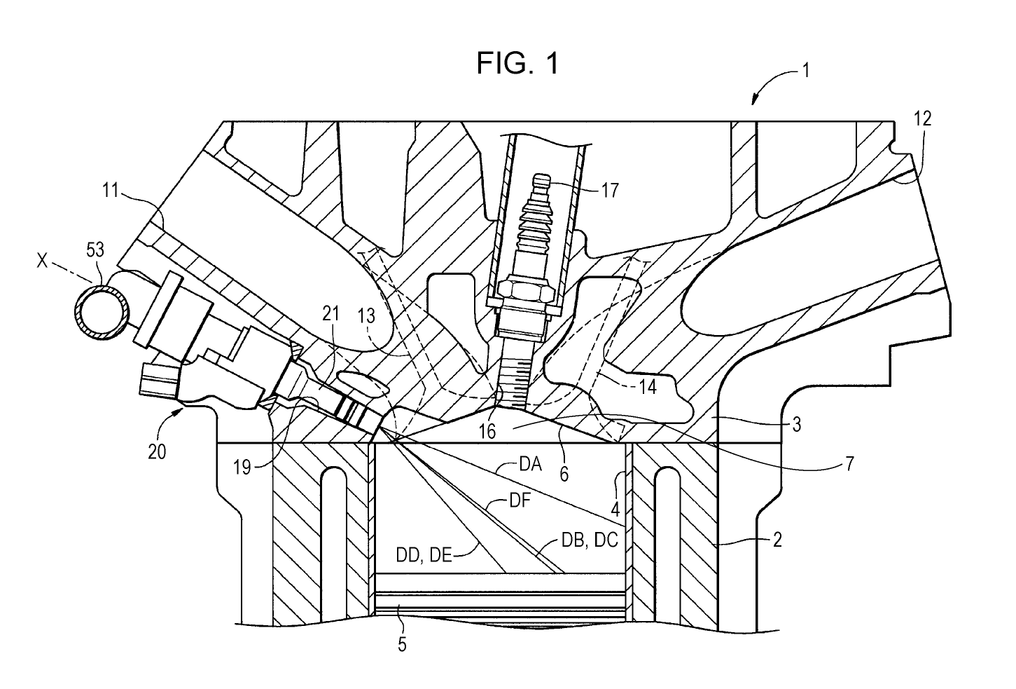

As illustrated in FIG. 1, an internal combustion engine 1 of an automobile includes a cylinder block 2 and a cylinder head 3 coupled to an upper portion of the cylinder block 2. The cylinder block 2 has cylinders 4 in which pistons 5 are slidably received along the axes of the cylinders 4. Combustion chamber recesses 6 having a substantially semispherical recessed shape are formed in portions of the cylinder head 3 facing the cylinders 4. Combustion chambers 7 are formed between the combustion chamber recesses 6 and upper surfaces of the pistons 5.

A pair of inlet ports 11 are formed on one side of each of the combustion chamber recesses 6. Each of the inlet ports 11 extends from the corresponding combustion chamber recess 6 to a side wall of the one side of the cylinder head 3 and is open. A pair of outlet ports 12 are formed on another side of each of the combustion chamber recesses 6. Each of the outlet ports 12 extends from the corresponding combustion chamber recess 6 to the side wall of the other side of the cylinder head 3 and is open. An inlet valve 13 and an outlet valve 14 are respectively provided at an interface between each the inlet ports 11 and the corresponding combustion chamber recess 6 and at an interface between each of the outlet ports 12 and the corresponding combustion chamber recess 6. The inlet valves 13 and the outlet valves 14 are poppet valves that open and close the corresponding ports. In a central portion of each of the combustion chamber recesses 6, an ignition plug attachment hole 16 that extends in the up-down direction through the cylinder head 3 is formed in a portion surrounded by the outlet ports 12 and the inlet ports 11. An ignition plug 17 is inserted into and secured to the ignition plug attachment hole 16.

An inner end of an injector hole 19 is open between the pair of inlet ports 11 at an edge of the one side of each of the combustion chamber recesses 6. The injector holes 19 each extend along a linear axis and have an outer end that is open in the side wall of the one side of the cylinder head 3. The outer end of the injector hole 19 is, in the side wall on the one side, closer to the cylinder block 2 than the inlet ports 11.

Injectors 20 are inserted into the injector holes 19. Each of the injectors 20 extends along a specified axis. When one end side of the injector 20 along the axis is defined as a distal end and another end side opposite to the one end side is defined as a proximal end, the injector 20 is inserted into the injector hole 19 such that the distal end of the injector 20 faces a corresponding one of the combustion chambers 7 and a proximal end side of the injector 20 projects from the injector hole 19 to the outside of the cylinder head 3.

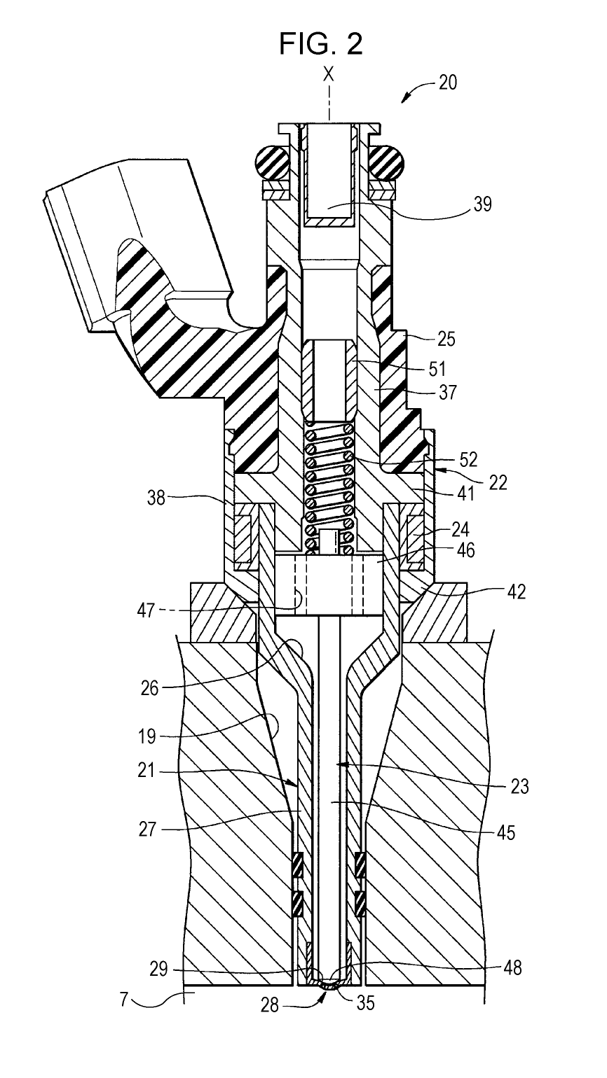

As illustrated in FIG. 2, the injector 20 includes a nozzle 21 provided on the distal end side, a housing 22 connected to the proximal end side of the nozzle 21, a valve body 23 received in the nozzle 21 such that the valve body 23 can be advanced and retracted, and a solenoid 24 supported by the nozzle 21 and the housing 22. A covering member 25 formed of resin is provided on an outer surface of the housing 22 by insert molding.

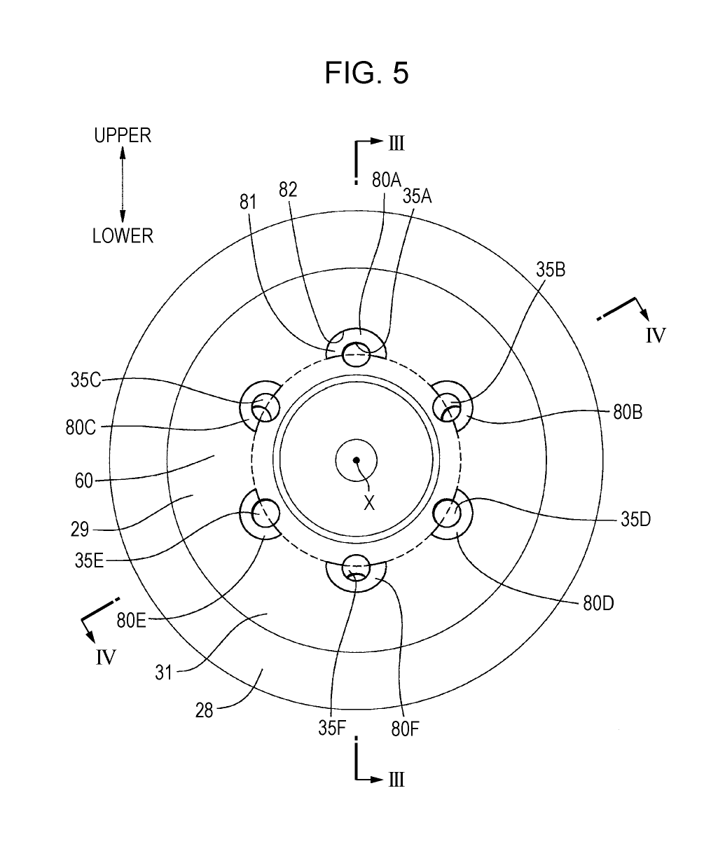

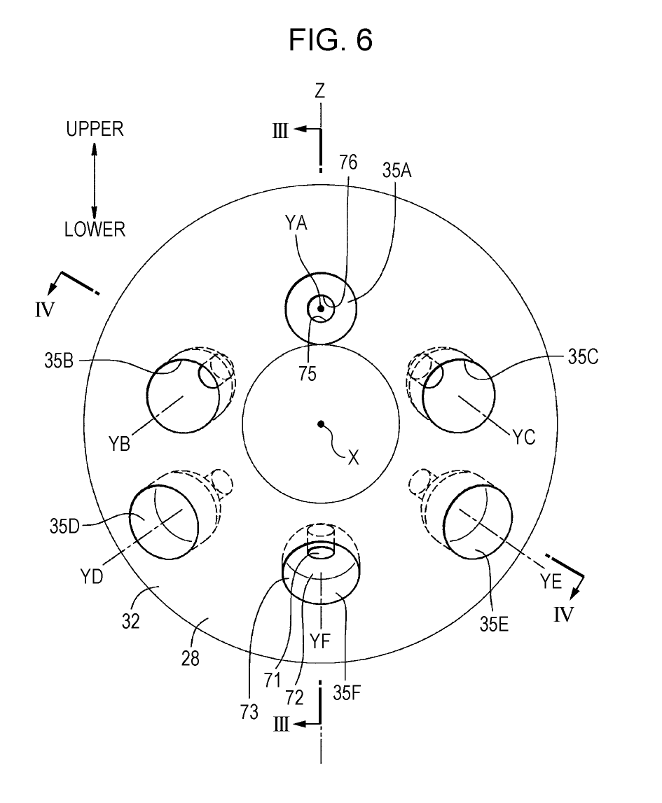

The nozzle 21 extends along a specified axis X (referred to as “nozzle axis X” hereafter) and includes a cylindrical nozzle main body 27 having therein a first channel 26 through which fuel flows. The nozzle axis X is coaxial with the axis of the injector 20. A proximal end portion of the nozzle main body 27 has a diameter enlarged relative to that of a distal end portion of the nozzle main body 27 and is open toward the proximal end side. The distal end portion of the nozzle main body 27 is closed by a nozzle distal end portion 28. Although the nozzle distal end portion 28 is a separate component combined with the nozzle main body 27 according to the present embodiment, the nozzle distal end portion 28 may be integrated with the nozzle main body 27 according to a different embodiment. The nozzle distal end portion 28 has an inner surface 31 on a portion thereof facing the proximal end side (first channel 26 side) and an outer surface 32 on a portion facing the distal end side. Although it will be described in detail later, the nozzle distal end portion 28 has a valve seat 29 in the inner surface 31 and a plurality of injection holes 35 that penetrate therethrough from the inner surface 31 to the outer surface 32. According to the present embodiment, first to sixth injection holes 35A, 35B, 35C, 35D, 35E, and 35F are formed (see FIGS. 5 and 6). Suffixes A to F added to reference numerals represent elements corresponding to the first to sixth injection holes 35A to 35F in the following description. The suffixes A to F are omitted when the injections 35 A to F or the corresponding elements are generally referred to.

As illustrated in FIG. 2, the housing 22 is formed by combining a first housing 37 and a second housing 38. The first housing has a cylindrical shape both ends of which are open and has therein a second channel 39 through which the fuel flows. One end of the first housing 37 is inserted into a proximal end opening of the nozzle main body 27. Thus, the first channel 26 and the second channel 39 are connected to each other. The first housing 37 has an annular first flange 41 radially outwardly projecting from a portion of an outer surface of the first housing 37 separated from the one end of the first housing 37 by a specified distance. Through contact of the first flange 41 with a proximal end surface of the nozzle main body 27, the positions of the nozzle main body 27 and the first housing 37 relative to each other are determined. The first flange 41 projects further toward the outside than an outer circumferential surface of the proximal end portion of the nozzle main body 27.

The second housing 38 has a cylindrical shape both ends of which are open and has an annular second flange 42 radially inwardly projecting from a distal end portion of the second housing 38. The second housing 38 is attached on an outer circumferential side of the nozzle main body 27 and the first housing 37 such that an inner circumferential surface of the second housing 38 is in contact with an outer circumferential surface of the first flange 41 and an inner circumferential surface of the second flange 42 is in contact with the outer circumferential side of the proximal end portion of the nozzle main body 27. An annular space centered at the nozzle axis X is defined by the proximal end portion of the nozzle main body 27, the second housing 38, the first flange 41, and the second flange 42. An annular solenoid 24 is disposed in this annular space. The solenoid 24 is connected to terminals in a connector formed of the covering member 25 through wiring. The solenoid 24 is connected to a control circuit through the terminals so as to be supplied with power.

The valve body 23 includes a columnar needle 45 and a disc portion 46. The needle 45 extends along the nozzle axis X in the first channel 26. The disc portion 46 is provided at a proximal end of the needle 45 so as to be coaxial with the needle 45. The disc portion 46 has a specified thickness, and an outer circumferential surface of the disc portion 46 is in sliding contact with an inner circumferential surface of the proximal end portion of the nozzle main body 27. The disc portion 46 has a plurality of passage holes 47 penetrating therethrough in the thickness direction. The valve body 23 is displaceable relative to the nozzle 21 in a direction along the nozzle axis X. A distal end portion 48 of the needle 45 has a shape that can sit on the valve seat 29.

A cylindrical spring seat 51 both ends of which are open is press fitted into the second channel 39 of the first housing 37. A spring 52 which is a compression coil spring is disposed between the spring seat 51 and the disc portion 46. The spring 52 urges the valve body 23 in a direction in which the valve body 23 sits on the valve seat 29, that is, urges the valve body 23 to the distal end side relative to the nozzle 21.

A fuel pipe 53 is connected to the proximal end portion of the first housing 37. The fuel the pressure of which has been increased by a fuel pump is supplied to the first and second channels 26 and 39 through the fuel pipe 53. In a valve closed state in which the valve body 23 sits on the valve seat 29, supply of the fuel into the injection holes 35 is interrupted, and no fuel is injected through the injection holes 35. When the power is supplied to the solenoid 24, a distal end portion of the first housing 37 is magnetized by the solenoid 24. Thus, the disc portion 46 is attracted to the distal end portion of the first housing 37, and the valve body 23 is separated from the valve seat 29. Thus, the fuel is supplied to the injection holes 35 and injected through the injection holes 35.

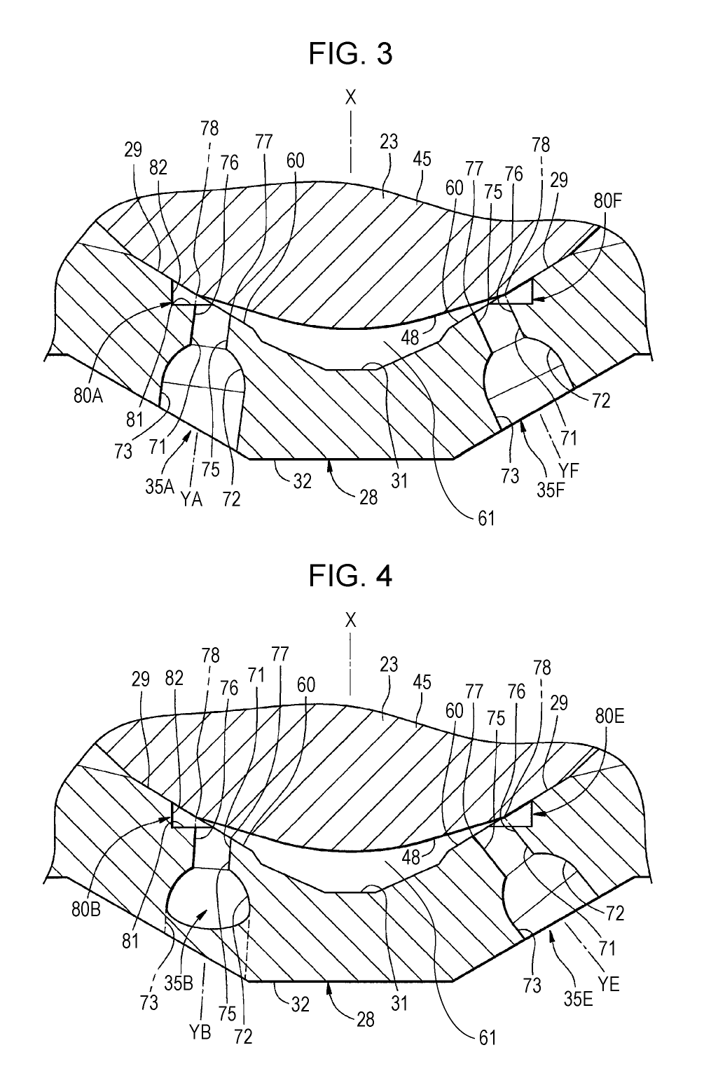

The details of a structure of the nozzle distal end portion 28 and around the nozzle distal end portion 28 are described below. As illustrated in FIGS. 3 and 4, the inner surface 31 of the nozzle distal end portion 28 has a tapered surface 60, which is a recess toward the distal end side centered at the nozzle axis X. The distance between the nozzle axis X and the tapered surface 60 gradually reduces from the proximal end side to the distal end side. The tapered surface 60 has an annular shape centered at the nozzle axis X. A portion of the inner surface 31 inside the tapered surface 60 is recessed toward the distal end side relative to the tapered surface 60. A projecting surface that projects toward the distal end side corresponding to the tapered surface 60 is formed in a central portion of the outer surface 32 of the nozzle distal end portion 28.

An outer circumferential portion (that is, the proximal end portion) of the annular tapered surface 60 forms the annular valve seat 29. An outer surface of the distal end portion 48 of the needle 45 forms a semispherical surface, a frusto-conical surface, or the like. The outer surface of the distal end portion 48 of the needle 45 and the valve seat 29 form an annular contact surface centered at the nozzle axis X. When the distal end portion 48 of the needle 45 sits on the valve seat 29, a gap 61 is formed between the outer surface of the distal end portion 48 of the needle 45 and an inner circumferential portion (that is, the distal end portion) of the tapered surface 60 and between the outer surface of the distal end portion 48 of the needle 45 and the inner surface 31. In the valve closed state in which the distal end portion 48 of the needle 45 sits on the valve seat 29, mutual shutoff is achieved by the gap 61, the first channel 26, and the valve body 23.

Open ends of the injection holes 35 on the inner surface 31 side (referred to as “inner ends” hereafter) are formed in the inner circumferential portion of the tapered surface 60. Part of the inner end of each of the injection holes 35 may be superposed on the valve seat 29. The inner ends of the injection holes 35A to 35F are equally spaced from one another on a specified circumference centered at the nozzle axis X. In the up-down direction with reference to a cylinder axis of the internal combustion engine 1, the first injection hole 35A is disposed at an uppermost portion of the circumference, the sixth injection hole 35F is disposed at a lowermost portion of the circumference, the second and third injection holes 35B and 35C are disposed at respective positions next to the first injection hole 35A, and the fourth and fifth injection holes 35D and 35E are disposed at respective positions next to the sixth injection hole 35F. That is, when seen from the inner surface 31 side, the first injection hole 35A, the second injection hole 35B, the fourth injection hole 35D, the sixth injection hole 35F, the fifth injection hole 35E, and the third injection hole 35C are arranged in this order clockwise around the nozzle axis X (see FIG. 5).

As illustrated in FIGS. 3 and 4, each of the injection holes 35 has a small diameter portion 71, a tapered portion 72, and a large diameter portion 73 in this order from the proximal end side. The small diameter portion 71 and the large diameter portion 73 are circular holes each having a uniform diameter throughout its length. An inner diameter of the large diameter portion 73 is larger than an inner diameter of the small diameter portion 71. An inner diameter of the tapered portion 72 gradually increases from the proximal end side of the tapered portion 72 connected to the small diameter portion 71 toward the distal end side of the tapered portion 72 connected to the large diameter portion 73. The axes of the small diameter portion 71, the tapered portion 72, and the large diameter portion 73 are coincident with one another, thereby defining the axis Y of the injection hole 35.

As illustrated in FIG. 6, the axes Y of the injection holes 35 extend in different directions from one another. An axis YA of the first injection hole 35A, an axis YF of the sixth injection hole 35F, and the nozzle axis X are disposed in a common reference plane Z. The reference plane Z extends in the up-down direction (direction in which the cylinder axis extends) in a state in which the injector 20 is attached to the internal combustion engine 1. The axis YA of the first injection hole 35A is substantially parallel to the nozzle axis X. The axis YF of the sixth injection hole 35F is inclined downward relative to the nozzle axis X on the distal end side in the reference plane Z. The axis YB of the second injection hole 35B and an axis YC of the third injection hole 35C are symmetric with each other about the reference plane Z as a plane of symmetry (laterally symmetric). The axis YB of the second injection hole 35B and the axis YC of the third injection hole 35C are inclined downward and inclined laterally (in directions separating from the reference plane Z) relative to the nozzle axis X on the distal end side. An axis YD of the fourth injection hole 35D and an axis YE of the fifth injection hole 35E are symmetric with each other about the reference plane Z as a plane of symmetry (laterally symmetric). The axis YD of the fourth injection hole 35D and the axis YE of the fifth injection hole 35E are inclined downward and inclined laterally (in directions separating from the reference plane Z) relative to the nozzle axis X on the distal end side. The downward inclination angles and lateral inclination angles of the axis YD of the fourth injection hole 35D and the axis YE of the fifth injection hole 35E relative to the nozzle axis X are larger than those of the axis YB of the second injection hole 35B and the axis YC of the third injection hole 35C. The downward inclination angle of the axis YF of the sixth injection hole 35F relative to the nozzle axis X is smaller than those of the axis YB of the second injection hole 35B and the axis YC of the third injection hole 35C.

As illustrated in FIG. 1, fuel injection directions DA to DF of the first to sixth injection holes 35A to 35F diverge in the up-down direction when seen in a direction perpendicular to the cylinder axis and the nozzle axis X. A fuel injection direction DA of the first injection hole 35A is substantially parallel to the nozzle axis X. Downward inclination angles of a fuel injection direction DF of the sixth injection hole 35F, fuel injection directions DB and DC of the second and third injection holes 35B and 35C, fuel injection directions DD and DE of the fourth and fifth injection holes 35D and 35E relative to the nozzle axis X increase in this order.

As illustrated in FIGS. 3 and 4, in a hole wall that defines each of the injection holes 35, a portion on the nozzle axis X side (referred to as “nozzle central side” hereafter) is referred to as a hole-wall inner portion 75, and a portion on an opposite side to the nozzle axis X (referred to as “nozzle outer circumferential side”) is referred to as a hole-wall outer portion 76. Furthermore, a corner portion formed between the tapered surface 60 and the hole-wall inner portion 75 of the small diameter portion 71 of each of the injection holes 35 is referred to as an inner corner portion 77, and a corner portion formed between the tapered surface 60 and the hole-wall outer portion 76 of the small diameter portion 71 of each of the injection holes 35 is referred to as an outer corner portion 78. The outer corner portion 78, which is cut out by forming a recess portion 80, is defined in a virtual plane formed by extrapolating the hole-wall outer portion 76 and the tapered surface 60. The details of the recess portion 80 will be described later.

As illustrated in FIG. 3, an angle formed between the hole-wall inner portion 75 of the first injection hole 35A and the tapered surface 60 (angle of the inner corner portion 77) is an acute angle, and an angle formed between the hole-wall outer portion 76 of the first injection hole 35A and the tapered surface 60 (angle of the outer corner portion 78) is an obtuse angle. An angle formed between the hole-wall inner portion 75 of the sixth injection hole 35F and the tapered surface 60 is an acute angle, and an angle formed between the hole-wall outer portion 76 of the sixth injection hole 35F and the tapered surface 60 is an obtuse angle. As illustrated in FIG. 4, an angle formed between the hole-wall inner portion 75 of the second injection hole 35B and the tapered surface 60 is an acute angle, and an angle formed between the hole-wall outer portion 76 of the second injection hole 35B and the tapered surface 60 is an obtuse angle. An angle formed between the hole-wall inner portion 75 of the fifth injection hole 35E and the tapered surface 60 is an acute angle, and an angle formed between the hole-wall outer portion 76 of the fifth injection hole 35E and the tapered surface 60 (angle of the outer corner portion 78) is an obtuse angle. Although it is not illustrated, an angle formed between the hole-wall inner portion 75 of the third injection hole 35C, which is symmetrical with the second injection hole 35B, and the tapered surface 60 is an acute angle, and an angle formed between the hole-wall outer portion 76 of the third injection hole 35C, which is symmetrical with the second injection hole 35B, and the tapered surface 60 is an obtuse angle. Likewise, an angle formed between the hole-wall inner portion 75 of the fourth injection hole 35D, which is symmetric with the fifth injection hole 35E, and the tapered surface 60 is an acute angle, and an angle formed between the hole-wall outer portion 76 of the fourth injection hole 35D, which is symmetric with the fifth injection hole 35E, and the tapered surface 60 is an obtuse angle.

As illustrated in FIGS. 3 to 5, the recess portion 80 (a corresponding one of first to sixth recess portions 80A to 80F) recessed toward the distal end side is formed on the nozzle outer circumferential side of an edge of an inner end of each of the injection holes 35 in the tapered surface 60. Each of the recess portions 80 is formed so as to cut out an edge line of the outer corner portion 78 and extends in a circumferential direction of the small diameter portion 71 along the hole-wall outer portion 76. The recess portion 80 has a bottom portion 81 and a wall portion 82. The bottom portion 81 extends in a direction perpendicular to the nozzle axis X. The wall portion 82 extends substantially perpendicularly to the bottom portion 81 and forms an outer circumferential portion of the recess portion 80. The bottom portion 81 of the recess portion 80 is connected to the hole-wall outer portion 76 of the small diameter portion 71. The width of the recess portion 80 (width of the bottom portion 81) in the radial direction of the small diameter portion 71 is preferably from 80 to 150% of the radius of the small diameter portion 71. The depth of the recess portion 80 (height of the wall portion 82) is preferably from 80 to 150% of the radius of the small diameter portion 71.

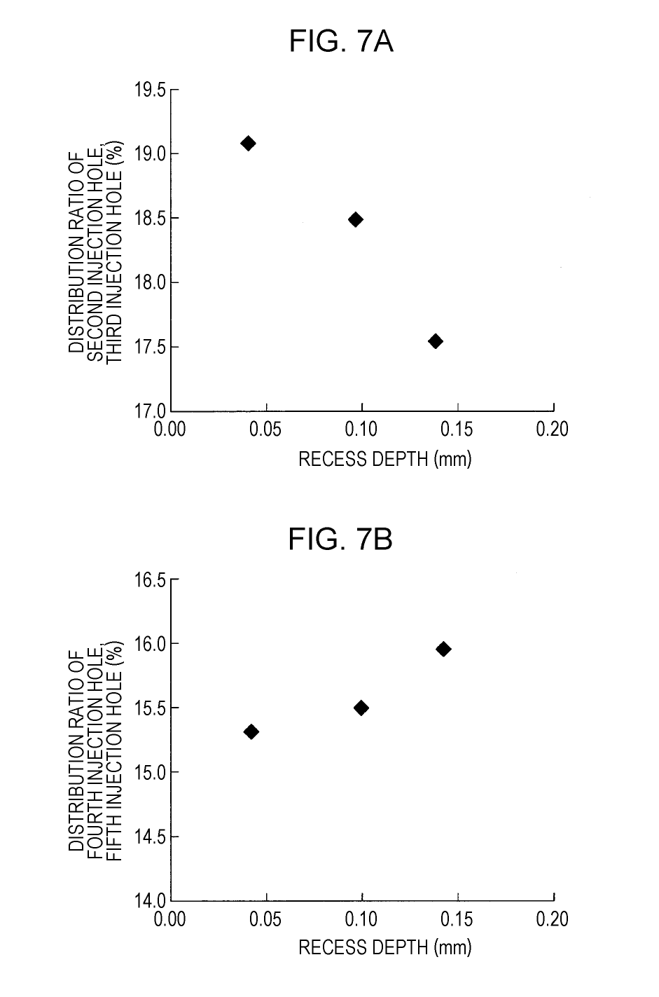

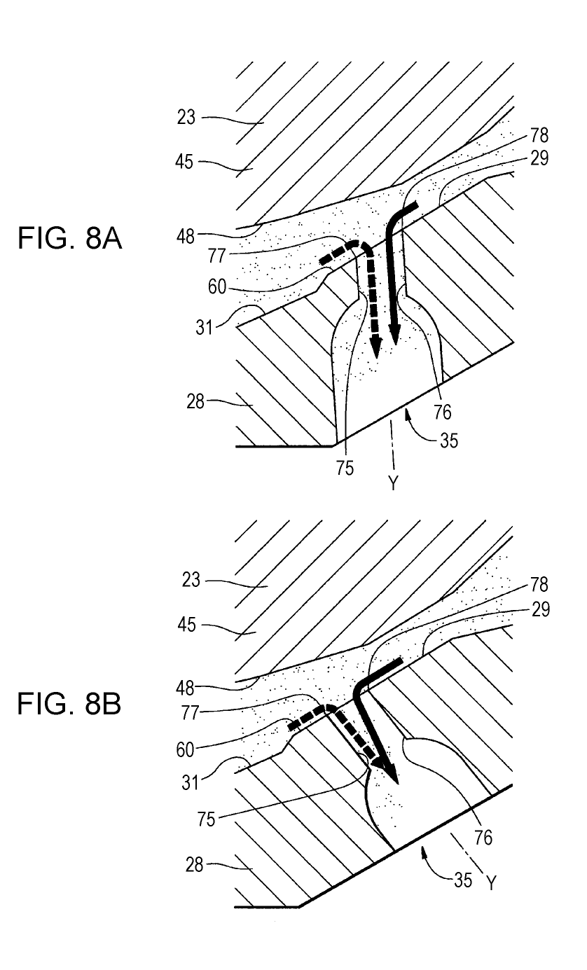

Effects of the injector 20 according the first embodiment structured as above are described. FIG. 7A is a graph illustrating the ratio of the amount of flow of the fuel passing through the second injection hole 35B or the third injection hole 35C when the valve is open. FIG. 7B is a graph illustrating the ratio of the flow amount of the fuel passing through the fourth injection hole 35D or the fifth injection hole 35E when the valve is open. The distribution ratio of FIGS. 7A and 7B are respectively the ratio of the flow amount of the second injection hole 35B and the third injection hole 35C and the ratio of the flow amount of the fourth injection hole 35D and the fifth injection hole 35E to the total flow amount of the first to sixth injection holes 35A to 35F. The second injection hole 35B and the third injection hole 35C are symmetric with each other and have the same geometry. Accordingly, the distribution ratios of the second injection hole 35B and the third injection hole 35C are equal to or substantially equal to each other. Likewise, the distribution ratios of the fourth injection hole 35D and the fifth injection hole 35E are equal to or substantially equal to each other.

Compared to the injector 20 according to the first embodiment, the recess portions 80 are omitted according to a comparative example. With an injector according to the comparative example, the distribution ratio (flow amount) of the first to third injection holes 35A to 35C is greater than that of the fourth to sixth injection holes 35D to 35F. This is caused by the directions of the axes Y of the injection holes 35. With the injector 20 according to the first embodiment similar to that of the comparative example, the fuel flows from the nozzle outer circumferential side to the nozzle central side when the valve body 23 is separated from the valve seat 29. Thus, in a radial direction centered at the nozzle axis X, of the flow of the fuel flowing through the inner end of each of the injection holes 35, part of the flow directed from the nozzle outer circumferential side to the injection hole 35 (inward part of flow) is stronger than part of flow directed from the nozzle central side to the injection hole 35 (outward part of flow).

As illustrated in FIG. 8A, in the case of each of, for example, the first to third injection holes 35A to 35C where the outer corner portion 78 is obtusely angled and the inner corner portion 77 is acutely angled, the inward part of the flow of the fuel can be bent along the hole-wall outer portion 76 and flows along the hole-wall outer portion 76 when flowing through the inner end of the injection hole 35. At this time, the outward part of the flow of the fuel is pushed by the inward part of the flow of the fuel. Thus, the outward part of the flow of the fuel can be bent along the acutely angled inner corner portion 77 and flows along the hole-wall inner portion 75. Thus, the sectional area of a flow path through which the fuel actually flows in the injection hole 35 becomes close to the sectional area of the injection hole 35. Thus, a comparatively large flow amount is obtained.

In contrast, as illustrated in FIG. 8B, in the case of each of, for example, the fourth to sixth injection holes 35D to 35F where the outer corner portion 78 is acutely angled and the inner corner portion 77 is obtusely angled, the inward part of the flow of the fuel cannot be bent so as to follow the hole-wall outer portion 76 when flowing through the inner end of the injection hole 35. Instead, the inward part of the flow of the fuel is separated from the hole-wall outer portion 76 and flows near the hole-wall inner portion 75 side. Accordingly, a space near the hole-wall outer portion 76 does not function as a flow path, and the sectional area of the flow path where the fuel is actually flows in the injection hole 35 is reduced compared to the case where the outer corner portion 78 is obtusely angled. Furthermore, since the outward part of the flow of the fuel is more strongly pushed by the inward part of the flow of the fuel, flowing of the fuel into the injection hole 35 is obstructed more than with the obtusely angled outer corner portion 78. Thus, when the outer corner portion 78 is acutely angled and the inner corner portion 77 is obtusely angled, the flow amount of the fuel passing through the injection hole 35 is reduced compared to the case where the outer corner portion 78 is obtusely angled and the inner corner portion 77 is acutely angled.

The injector 20 according to the present embodiment has recess portions 80 that enlarge flow paths of the fuel. The recess portions 80 are each disposed at the nozzle outer circumferential side of the edge of the inner end of a corresponding one of the injection holes 35. This reduces the flow speed of the fuel flowing from the nozzle outer circumferential side into each of the injection holes 35 in the recess portion 80. Thus, the difference in speed between the inward part of the flow of the fuel and the outward part of the flow of the fuel is reduced. This reduces an effect of the inward part of the flow of the fuel pushing the outward part of the flow of the fuel.

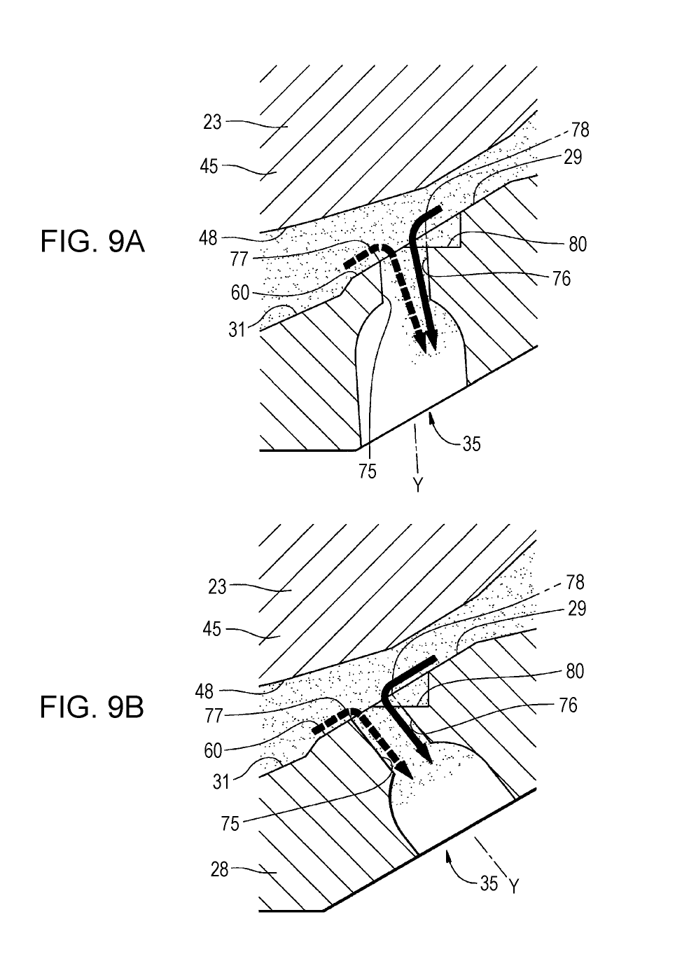

As illustrated in FIG. 9A, with the injector 20 according to the present embodiment, in the case of each of, for example, the first to third injection holes 35A to 35C where the outer corner portion 78 is obtusely angled and the inner corner portion 77 is acutely angled, the speed of the inward part of the flow of the fuel is reduced in the recess portion 80, and after that, the inward part of the flow of the fuel is bent so as to follow the hole-wall outer portion 76 and flows along the hole-wall outer portion 76. In contrast, with the reduced effect of the inward part of the flow of the fuel pushing part of the flow of the fuel from a nozzle inner circumferential side, the outward part of the flow of the fuel cannot be bent so as to follow the acutely angled inner corner portion 77. Instead, the outward part of the flow of the fuel is separated from the hole-wall inner portion 75 and flows near the hole-wall outer portion 76 side. Thus, with the injector 20 according to the present embodiment, in each of the injection holes 35 where the outer corner portion 78 is obtusely angled and the inner corner portion 77 is acutely angled, the sectional area of the flow path where the fuel is actually flows in the injection hole 35 becomes smaller than the sectional area of the injection hole 35, and accordingly, the flow amount of the fuel is reduced compared to that in a corresponding one of the injection holes 35 of the comparative example.

In contrast, with the injector 20 according to the present embodiment, as illustrated in FIG. 9B, in the case of each of, for example, the fourth to sixth injection holes 35D to 35F where the outer corner portion 78 is acutely angled and the inner corner portion 77 is obtusely angled, the inward part of the flow of the fuel cannot be bent so as to follow the hole-wall outer portion 76 when flowing through the inner end of the injection hole 35 after the speed of the inward part of the flow of the fuel has been reduced in the recess portion 80. Instead, the inward part of the flow of the fuel is separated from the hole-wall outer portion 76 and flows near the hole-wall inner portion 75 side. Since the flow speed of the inward part of the flow of the fuel is reduced, the outward part of the flow of the fuel more easily flows into each of the injection hole 35 than in the case of a corresponding one of the injection holes 35 according to the comparative example. Thus, with the injector 20 according to the present embodiment, in the case of each of the injection holes 35 where the outer corner portion 78 is acutely angled and the inner corner portion 77 is obtusely angled, the flow amount of the fuel is increased compared to that with a corresponding one of the injection holes 35 of the comparative example.

As illustrated in FIG. 7A, with each of the second and third injection holes 35B and 35C of the injector 20 according to the present embodiment, the distribution ratio is reduced as the depth of a corresponding one of the recess portions 80B and 80C is increased in an illustrated range. The reason for this is thought to be explained in accordance with the above description. Furthermore, as illustrated in FIG. 7B, with each of the fourth and fifth injection holes 35D and 35E of the injector 20 according to the present embodiment, the distribution ratio is increased as the depth of a corresponding one of the recess portions 80D and 80E is increased in an illustrated range. The reason for this is thought to be that, as a result of reduction of the distribution ratio of the second and third injection holes 35B and 35C, the distribution ratio of the fourth and the fifth injection holes 35D and 35E is relatively increased.

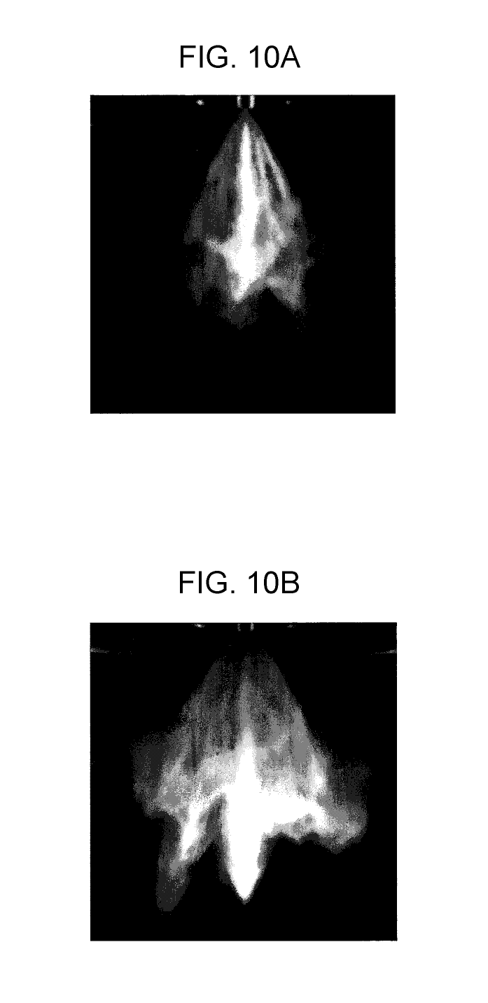

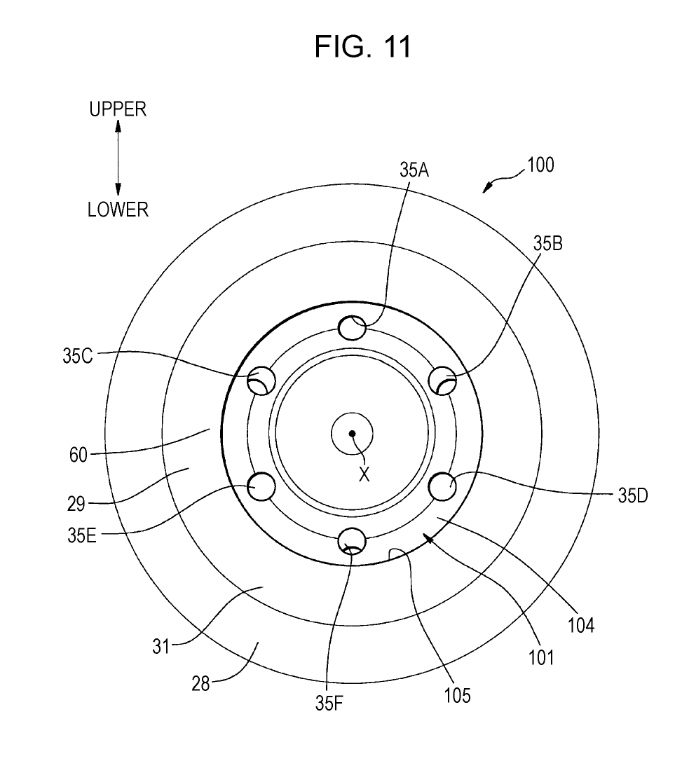

As illustrated in FIG. 10B, with the injector according to the comparative example, there is a large difference in fuel penetration (penetrability) between the injection holes 35 due to the difference in the flow amount. However, as illustrated in FIG. 10A, with the injector 20 according to the present embodiment, the difference in fuel penetration between the injection holes 35 is reduced. This prevents the fuel injected though some of the injection holes 35 from adhering to the cylinders 4 and the pistons 5.

### Second Embodiment

As illustrated in FIG. 11, the difference between an injector 100 according to a second embodiment and the injector 20 according to the first embodiment is that the injector 100 according to the second embodiment has a recess portion 101 having a different shape from those of the recess portions 80. Other elements of the injector 100 are the same as or similar to those of the injector 20. The injector 100 according to the second embodiment has the recess portion 101 that is recessed toward the distal end side in the tapered surface 60 and has an annular shape centered at the nozzle axis X. The recess portion 101 is disposed on the nozzle outer circumferential side of the edges of the inner ends of the injection holes 35 so as to cut out the ridge lines of the outer corner portions 78. The recess portion 101 has a bottom portion 104 and a wall portion 105. The bottom portion 104 is flat, extends in a direction perpendicular to the nozzle axis X, and has an annular shape centered at the nozzle axis X. The wall portion 105 extends substantially perpendicularly to the bottom portion 104 and forms a circumferential surface centered at the nozzle axis X. The bottom portion 104 of the recess portion 101 is connected to the hole-wall outer portions 76 of the small diameter portions 71. The width of the recess portion 101 (width of the bottom portion 104 in the radial direction of the nozzle axis X) is preferably from 80 to 150% of the radius of the small diameter portion 71. The depth of the recess portion 101 (height of the wall portion 105) is preferably from 80 to 150% of the radius of the small diameter portion 71.

By forming the recess portion 101 as a single continuous recess as the recess portion 101 of the injector 100 according to the second embodiment, the entirety of the recess portion 101 corresponding to the plurality of injection holes 35 can be formed by a single boring operation with a drill. Thus, processing is facilitated.

Although the specific embodiments have been described, the present disclosure is not limited to the above-described embodiments. The present disclosure can be embodied in a variety of modifications. The number, the orientation, and the shape of the injection holes 35 can be arbitrarily set. Furthermore, it is sufficient that the recess portions 80 be provided in the outer corner portions 78. The shape and the size of the recess portions 80 can be arbitrarily set.

According to an aspect of the present disclosure, an injector (20) includes a nozzle (21) and a valve body (23). The nozzle includes a cylindrical nozzle main body (27) and a nozzle distal end portion (28). The nozzle main body extends along a specified nozzle axis (X) and has therein a channel (26) for fuel through which the fuel flows. The nozzle distal end portion closes a distal end of the nozzle main body, has a valve seat (29) in an inner surface (31) facing a channel side, and has a plurality of injection holes (35) penetrating through the nozzle distal end portion from the inner surface of the nozzle distal end portion to an outer surface (32) of the nozzle distal end portion. The valve body is contained in the channel such that the valve body is displaceable along the nozzle axis and is able to sit on the valve seat. The inner surface of the nozzle distal end portion has a tapered surface in which a central side is inclined toward a distal end side around the nozzle axis as a center. The valve seat is formed in the inner surface to have an annular shape centered at the nozzle axis. Each of the plurality of injection holes has an inner-surface-side open end disposed closer to the central side than an outer circumferential edge of the valve seat, and each of the plurality of injection holes has a hole-wall inner portion (75) that forms part of a hole wall of the injection hole on a nozzle axis side and a hole-wall outer portion (76) that forms part of the hole wall of the injection hole on an opposite side to the nozzle axis. The plurality of injection holes include at least one first injection hole (35A, 35B, 35C), an angle formed between the hole-wall inner portion of the at least one first injection hole and the inner surface is an acute angle, an angle formed between the hole-wall outer portion of the at least one first injection hole and the inner surface is an obtuse angle, and a first recess portion (80A, 80B, 80C) is provided so as to extend from the inner surface to the hole-wall outer portion of the at least one first injection hole.

According to this aspect, a flow amount of the first injection hole, the flow amount of which is comparatively large, can be reduced with a simple structure. Typically, the fuel flows from the outer circumferential side to the central side of the nozzle in the inner surface of the nozzle distal end portion. Thus, as the angle formed between the hole-wall outer portion and the inner surface of each of the injection holes is increased as is the case with, for example, the first injection hole, an angle formed between a flowing direction of the fuel and an opening direction of the injection hole reduces. Thus, the fuel is easily flows into the injection hole, and accordingly, the flow amount increases. According to the above-described aspect of the present disclosure, the flow speed of part of a flow of the fuel inwardly directed from the outer circumferential side of the nozzle toward the injection hole (referred to as “inward part of the flow” hereafter) is reduced in the first recess portion where a flow path is enlarged. This reduces the difference in the flow speed between the inward part of the flow of the fuel and part of the flow of the fuel outwardly directed from the central side of the nozzle to the injection hole (referred to as “outward part of the flow” hereafter). Thus, an effect of the inward part of the flow pushing the outward part of the flow becomes weak, and accordingly, the outward part of the flow is unlikely to be bent so as to follow the hole-wall inner portion at the open end of the injection hole, and the outward part of the flow is separated from the hole-wall inner portion. Thus, the sectional area of the flow path where the fuel actually flows in the injection hole is reduced, and accordingly, the flow amount is reduced. As described above, an increase in the flow amount is suppressed even when the orientation of the injection hole is changed as is the case with the first injection hole.

Preferably, the plurality of injection holes include at least one second injection hole (35D, 35E, 35F), and an angle formed between the hole-wall inner portion of the at least one second injection hole and the inner surface is an obtuse angle, an angle formed between the hole-wall outer portion of the at least one second injection hole and the inner surface is an acute angle, and a second recess portion (80D, 80E, 80F) is provided so as to extend from the inner surface to the hole-wall outer portion of the at least one second injection hole.

With this form, a flow amount of the second injection hole, the flow amount of which is comparatively small, can be increased with a simple structure. Typically, as the angle formed between the hole-wall outer portion and the inner surface of each of the injection holes becomes small as is the case with, for example, the second injection hole, the angle formed between the inward part of the flow and an opening direction of the injection hole increases, and accordingly, the inward part of the flow is unlikely to be bent so as to follow the hole-wall outer portion at the open end of the injection hole, and the inward part of the flow is separated from the hole-wall inner portion. Thus, the sectional area of the flow path where the fuel actually flows in the injection hole is reduced, and accordingly, the flow amount is reduced. With this form of the present disclosure, the flow speed of inward part of the flow is reduced in the second recess portion where the flow path is enlarged. This reduces the difference in the flow speed between the inward part of the flow and the outward part of the flow. Thus, an effect of the inward part of the flow pushing the outward part of the flow becomes strong, and accordingly, the outward part of the flow is likely to be bent so as to follow the hole-wall outer portion at the open end of the injection hole. Thus, reduction on the sectional area of the flow path where the fuel actually flows in the injection hole is suppressed, and accordingly, the flow amount is increased. As described above, the reduction in the flow amount is suppressed even when the orientation of the injection hole is changed as is the case with the second injection hole.

Preferably, the first recess portion and the second recess portion are continuous with each other so as to have an annular shape centered at the nozzle axis.

With this form, the entirety of the recess portion corresponding to the injection holes can be formed by a single boring operation. Thus, processing is facilitated.

Preferably, in each of the plurality of injection holes, the hole-wall outer portion and the hole-wall inner portion form a common cylindrical surface.

With this form, the injection holes are easily formed.

With the above-described structure, easy adjustment of orientations and flow amounts of injection holes of an injector can be realized.

Obviously, numerous modifications and variations of the present invention are possible in light of the above teachings. It is therefore to be understood that within the scope of the appended claims, the invention may be practiced otherwise than as specifically described herein.

What is claimed is:

1. An injector comprising:
a nozzle that includes
a cylindrical nozzle main body that extends along a specified nozzle axis and that has therein a channel for fuel through which the fuel flows, and
a nozzle distal end portion that closes a distal end of the nozzle main body, that has a valve seat in an inner surface facing a channel side, and that has a plurality of injection holes penetrating through the nozzle distal end portion from the inner surface of the nozzle distal end portion to an outer surface of the nozzle distal end portion; and
a valve body that is contained in the channel such that the valve body is displaceable along the nozzle axis and that is able to sit on the valve seat,
wherein the inner surface of the nozzle distal end portion has a tapered surface in which a central side is inclined toward a distal end side around the nozzle axis as a center,
wherein the valve seat is formed in the inner surface to have an annular shape centered at the nozzle axis,
wherein each of the plurality of injection holes has an inner-surface-side open end disposed closer to the central side than an outer circumferential edge of the valve seat, and each of the plurality of injection holes has a hole-wall inner portion that forms part of a hole wall of the injection hole on a nozzle axis side and a hole-wall outer portion that forms part of the hole wall of the injection hole on an opposite side to the nozzle axis, and
wherein the plurality of injection holes include at least one first injection hole, an angle formed between the hole-wall inner portion of the at least one first injection hole and the inner surface is an acute angle, an angle formed between the hole-wall outer portion of the at least one first injection hole and the inner surface is an obtuse angle, and a first recess portion is provided so as to extend from the inner surface to the hole-wall outer portion of the at least one first injection hole.

2. The injector according to claim 1,
wherein the plurality of injection holes include at least one second injection hole, and
wherein an angle formed between the hole-wall inner portion of the at least one second injection hole and the inner surface is an obtuse angle, an angle formed between the hole-wall outer portion of the at least one second injection hole and the inner surface is an acute angle, and a second recess portion is provided so as to extend from the inner surface to the hole-wall outer portion of the at least one second injection hole.

3. The injector according to claim 2,
wherein the first recess portion and the second recess portion are continuous with each other so as to have an annular shape centered at the nozzle axis.

4. The injector according to claim 1,
wherein, in each of the plurality of injection holes, the hole-wall outer portion and the hole-wall inner portion form a common cylindrical surface.

5. An injector comprising:
a cylindrical nozzle main body having a nozzle axis and a channel which extends along the nozzle axis to a distal end of the cylindrical nozzle main body and through which the fuel flows;
a nozzle distal end portion connected to the distal end of the cylindrical nozzle main body and having an inner surface and an outer surface opposite to the inner surface in the nozzle axis, the inner surface facing the channel and having a valve seat which has an annular shape on the inner surface having a center at the nozzle axis, the nozzle distal end portion having a plurality of injection holes penetrating through the nozzle distal end portion from the inner surface of the outer surface, the plurality of injection holes having on the inner surface an inner-surface-side opening which is provided between the nozzle axis and an outer circumferential edge of the valve seat, each of the plurality of injection holes being defined by a hole wall which has a hole-wall inner portion closest to the nozzle axis and a hole-wall outer portion furthest from the nozzle axis, the plurality of injection holes including at least one first injection hole, an angle between the inner surface and the hole-wall inner portion of the at least one first injection hole being an acute angle, an angle between the inner surface and the hole-wall outer portion of the at least one first injection hole being an obtuse angle, a first recess portion being provided on the inner surface to extend to the hole-wall outer portion of the at least one first injection hole; and
a valve body provided in the channel and movable along the nozzle axis to be able to sit on the valve seat.

6. The injector according to claim 5,
wherein the plurality of injection holes include at least one second injection hole, and
wherein an angle between the hole-wall inner portion of the at least one second injection hole and the inner surface is an obtuse angle, an angle between the hole-wall outer portion of the at least one second injection hole and the inner surface is an acute angle, and a second recess portion is provided on the inner surface to extend to the hole-wall outer portion of the at least one second injection hole.

7. The injector according to claim 6,
wherein the first recess portion and the second recess portion are continuous with each other so as to have an annular shape centered at the nozzle axis.

8. The injector according to claim 5,
wherein, in each of the plurality of injection holes, the hole-wall outer portion and the hole-wall inner portion form a common cylindrical surface.
